(19) United States
(12) Patent Application Publication
(10) Pub. No.: US 2018/0145341 A1
(43) Pub. Date: May 24, 2018

(54) COMPONENT FOR FUEL CELL INCLUDING GRAPHENE FOAM AND FUNCTIONING AS FLOW FIELD AND GAS DIFFUSION LAYER

(71) Applicants: Seoul National University, R&DB Foundation, Seoul (KR); Institute for Basic Science, Daejeon (KR); Kangwon National University, University-Industry Cooperation Foundation, Chuncheon City (KR)

(72) Inventors: Yung-Eun SUNG, Seoul (KR); Yong-Hun CHO, Gunpo-si (KR); Ji Eun PARK, Seoul (KR); Chi-Yeong AHN, Suncheon-si (KR); Sungjun KIM, Seoul (KR)

(73) Assignees: Seoul National University, R&DB Foundation, Seoul (KR); Institute for Basic Science, Daejeon (KR); Kangwon National University, University-Industry Cooperation Foundation, Chuncheon City (KR)

(21) Appl. No.: 15/814,839

(22) Filed: Nov. 16, 2017

(30) Foreign Application Priority Data
Nov. 24, 2016 (KR) 10-2016-0157713

(51) Int. Cl. H01M 8/0234; H01M 8/0258; H01M 8/1018; H01M 8/241; H01M 8/04007

(52) U.S. Cl. CPC H01M 8/0234; H01M 8/0258; H01M 2008/1095; H01M 8/241; H01M 8/04007; H01M 8/1018

(57) ABSTRACT

The present invention relates to a component including graphene foam and functioning as a flow field and a gas diffusion layer (GDL) for a fuel cell. More particularly, a component functioning as a flow field and a GDL for a fuel cell according to the present invention is made of graphene foam that enhances mass transport and suffers no corrosion under operating conditions of the fuel cell when compared with a conventional flow field, thereby realizing excellent performance and durability. Furthermore, the component functions as the GDL so a thickness of a membrane electrode assembly is reduced thereby improving cell performance significantly.

### CROSS REFERENCE TO RELATED APPLICATION

The present application claims priority to Korean Patent Application No. 10-2016-0157713, filed Nov. 24, 2016, the entire contents of which is incorporated herein for all purposes by this reference.

### BACKGROUND OF THE INVENTION

### Field of the Invention

The present invention relates generally to a component included in a fuel cell. More particularly, the present invention relates to a component functioning as a flow field and a gas diffusion layer.

### Description of the Related Art

Hydrogen is most abundant element on earth and can be changed to renewable energy without discharging greenhouse gas and polluted material. In particular, when using hydrogen as a fuel of fuel cells converting chemical energy, generated by chemical reaction between reactants, into electrical energy directly, such fuel cells have excellent efficiency about 2.5 times of internal combustion engines. Therefore, fuel cells using hydrogen have attracted considerable attention as a future technology for converting energy.

Based on types of electrolyte, such fuel cells may be classified into a polymer electrolyte membrane fuel cell (PEMFC), an alkaline fuel cell (AFC), a phosphoric acid fuel cell (PAFC), a molten-carbonate fuel cell (MCFC), a solid oxide fuel cell (SOFC), and so on. In particular, the PEMFC has low operation temperature and high energy density, and is capable of reducing size thereof and using hydrogen or methanol as a fuel. Therefore, when the PEMFC is applied as a distributed energy system, the PEMFC may be flexibly adjusted in sizes and combinations with other elements so it is estimated that the PEMFC may be soon commercially available.

A membrane electrode assembly (MEA) of such PEMFC generally includes a polymer electrolyte membrane, a cathode and anode disposed at each surface of the polymer electrolyte membrane, and, a gas diffusion layer (GDL) disposed at surfaces of the cathode and anode.

Here, the GDL performs functions as a channel for product and water, an electrical connecting part, and a mechanical support. Specifically, the GDL is a porous carbon-based material made of carbon paper obtained by compressing carbon fiber. The GDL diffuses reactants from a channel of a bipolar plate into a catalyst layer and removes generated water to outside of the catalyst layer. In addition, the GDL transports electrons between the bipolar plate and the catalyst layer and acts as a mechanical support of the MEA. The GDL is an important component for managing water in the PEMFC.

A conventional GDL consists of carbon paper treated with polytetrafluoroethylene (PTFE) and a micro-porous layer (MPL). PTFE coating is a hydrophobic treatment and removes water from the catalyst layer so as to prevent water flooding. The MPL provides wide surface area and excellent contact between the carbon paper and the catalyst layer.

Meanwhile, the GDL has high electrical conductivity but inevitably causes electrical resistance and mass transport resistance. In addition, two GDLs (˜500 μm) are much thicker than a catalyst coated membrane (CCM) (˜70 μm) such that the GDLs occupy a large volume in the MEA.

Such GDL functions as a channel for product and water, however, mass transport is negatively affected thereby. The reason is that even though the GDL has high electrical conductivity, the GDL increases electrical resistance of cells, and as the GDL becomes thick, reactant pathways are increased.

Therefore, when the GDL is removed from the MEA, electrical resistance is reduced due to reduction in components and reactant pathways disposed from the bipolar plate to the catalyst layer are reduced thereby reducing mass transport resistance. Moreover, volume of a stack is decreased and volume power density is increased, due to decreased thickness of a MEA of a single cell.

However, to take advantages of removing a GDL, a cell component functioning as a flow field and a GDL is needed to be developed.

### DOCUMENTS OF RELATED ART

(Patent Document 1) Korean Patent Publication No. 10-2012-0049223 (May 16, 2012);

(Patent Document 2) Korean Patent Publication No. 10-2015-0096219 (Aug. 24, 2015);

(Patent Document 3) Japan Patent Publication No. 2003-142130 (May 16, 2003); and

(Patent Document 4) U.S. Pat. No. 6,037,073 (May 14, 2000).

### SUMMARY OF THE INVENTION

Accordingly, the present invention has been made keeping in mind the above problems occurring in the related art, and the present invention is intended to provide a novel component for a fuel cell, in which no separate gas diffusion layer (GDL) is provided in a membrane electrode assembly and the function of the GDL is integrated in the component, thereby improving cell performance.

In order to achieve the above objects, there is provided a component functioning as a flow field and a gas diffusion layer (GDL) of a fuel cell, the component including graphene foam.

In addition, the component may be a sheet or a film made of the graphene foam.

In addition, the graphene foam may be compressed graphene foam.

In addition, the fuel cell may be a polymer electrolyte membrane fuel cell (PEMFC).

In addition, the sheet or the film made of the graphene foam may be interposed between a catalyst coated membrane (CCM) and a bipolar plate when manufacturing the fuel cell.

Furthermore, as another aspect of the present invention, there is provided a fuel cell including the component functioning as the flow field and the GDL.

In addition, the fuel cell includes: a stack laminated with multiple single cells composed by sequentially binding the CCM, configured to bind anode and cathode on each side of an electrolyte membrane containing electrolyte, and the bipolar plate and the component functioning as the flow field and the GDL sequentially bound on each side of the CCM; an inlet line connected to the stack to supply gas to an inside of the stack;

an outlet line connected to the stack to discharge gas from the stack; and a heat exchanger connecting the inlet line and the outlet line to heat-exchange inlet gas flowing through the inlet line and outlet gas flowing through the outlet line.

The component functioning as the flow field and the GDL for the fuel cell according to the present invention is made of the graphene foam that enhances mass transport and suffers no corrosion under operating conditions of the fuel cell when compared with a conventional flow field, thereby realizing excellent performance and durability.

In detail, when applying the component including the graphene foam and functioning as the flow field and the GDL for the fuel cell, a membrane electrode assembly (MEA) having decreased thickness due to removal of the GDL enables decreasing reactant transport pathway from a bipolar plate to a catalyst layer and reducing mass transport resistance. In addition, the compressed graphene foam provides a tortuous pathway which captures reactants, diffuses more reactants into the GDL, and decreases activation loss by generating high pressure. In addition, large through-plane pores transport reactants to entire regions of the catalyst layer. Furthermore, faster flow velocity compared with the conventional MEA is derived from a decreased width of the flow field due to compression, thereby facilitating the dragging of water droplets generated from reaction through unused reactant flow to outside. Therefore, mass transport of reactants and products is improved thereby improving cell performance.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows schematic views of a MEA having a flow field made of graphene foam as a fuel cell component integrated a gas diffusion layer made of graphene foam and a flow field, and a conventional MEA having a serpentine flow field;

FIG. 2A shows schematic views of a conventional MEA and a conventional MEA without a flow field, and FIG. 2B shows polarization curves of the conventional MEA and the conventional MEA without the flow field, wherein the MEAs were conducted a polarization test at 70° C. H²/air, fully humidified at atmospheric pressure;

FIG. 3A is a SEM image showing a top plan view of graphene foam before compression, FIG. 3B is a SEM image showing a cross-sectional view of graphene foam before compression, FIG. 3C is a SEM image showing a cross-sectional view of graphene foam after compression (thickness of 250 μm), FIG. 3D is a SEM image showing a cross-sectional view of graphene foam after compression (thickness of 200 μm), FIG. 3E is a SEM image showing a cross-sectional view of graphene foam after compression (thickness of 150 μm), and FIG. 3F is a SEM image showing a cross-sectional view of graphene foam after compression (thickness of 100 μm), with scale bar of 100 μm;

FIG. 4 shows polarization curves of MEAs having different thicknesses of graphene foam;

FIG. 5 shows polarization curves of a MEA having a flow field made of graphene foam (graphene foam thickness of 200 μm) and a conventional MEA, wherein the MEAs had catalyst loading of 0.2 mg·cm-2 and a polarization test was performed at 70° C. with fully humidified H2/air;

FIG. 6 shows oxygen gain graphs of a MEA having a flow field made of graphene foam (graphene foam thickness of 200 μm) and a conventional MEA at high current density regions;

FIG. 7A shows Randles equivalent circuit model for electrochemical impedance spectroscopy (EIS), FIG. 7B shows EIS Nyquist plots of a MEA having a flow field made of compressed graphene foam and a conventional MEA at 0.8 V, and FIG. 7C shows EIS Nyquist plots of the MEA having the flow field made of the compressed graphene foam and the conventional MEA at 0.4 V under a fully humidified H₂/air;

FIG. 8A shows schematic views of a MEA having a flow field made of compressed graphene foam (200 μm-GF MEA) and a MEA having a flow field made of compressed graphene foam with a gas diffusion layer (200 μm-GF MEA having GDL), FIG. 8B shows polarization curves of the 200 μm-GF MEA and the 200 μm-GF MEA with GDL, and FIG. 8C shows IR-corrected cell voltage curves of the 200 μm-GF MEA and the 200 μm-GF MEA having the GDL, wherein the MEAs were conducted a polarization test at 70° C. H²/air, fully humidified at atmospheric pressure;

FIG. 9 shows EIS Nyquist plots of a MEA having a flow field made of compressed graphene foam (200 μm-GF MEA) and a MEA having a flow field made of compressed graphene foam with a gas diffusion layer (200 μm-GF MEA having GDL) at 0.6 V.

### DETAILED DESCRIPTION OF THE INVENTION

Exemplary embodiments of the present invention will be described more fully hereinafter with reference to the accompanying drawings. In the following description of the present invention, detailed descriptions of known functions and components incorporated herein will be omitted when it may make the subject matter of the present invention unclear.

Reference will now be made in detail to various embodiments of the present invention, specific examples of which are illustrated in the accompanying drawings and described below, since the embodiments of the present invention can be variously modified in many different forms. While the present invention will be described in conjunction with exemplary embodiments thereof, it is to be understood that the present description is not intended to limit the present invention to those exemplary embodiments. On the contrary, the present invention is intended to cover not only the exemplary embodiments, but also various alternatives, modifications, equivalents and other embodiments that may be included within the spirit and scope of the present invention as defined by the appended claims.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinbelow, the present invention will be described in detail.

A component functioning as a flow field and a gas diffusion layer (GDL) of a fuel cell according to the present invention includes graphene foam.

Graphene foam is a material combining structural characteristics of graphene and metal foam and has a successive three-dimensional connective network structure. In addition, the graphene foam has no junction resistance between graphene layers configured to form the graphene foam and provides an internal connective structure having high conductivity with no defects between the graphene layers. Furthermore, graphene foam has a 99.7% degree of porosity and thereby can be ideally applied as a scaffold having synergy effect by complexation with other materials.

In particular, the graphene foam has in-plane pores and through-plane pores thereby functioning as the GDL and the flow field at the same time.

Meanwhile, physical properties of the graphene foam are not specifically limited, but as an example, an interlayer space of the graphene layers configured to foam the graphene foam may be greater than 0 and equal to or less than 0.34 nm and the graphene foam may include micropores in a range of 100 μm to 300 μm and the porosity thereof may be 80% to 99.7%.

It is preferable that the component functioning as the flow field and the GDL made of graphene foam may be a sheet or a film made of the graphene foam. Such form may be easily manufactured by interposing the graphene foam sheet or film between a catalyst coated membrane (CCM) and a bipolar plate, for example, when manufacturing a polymer electrolyte membrane fuel cell (PEMFC).

Meanwhile, it is preferable that the graphene foam is compressed by applying compressive stress. A high porosity of the graphene foam before compression, which exceeds 90%, facilitates reactants passing the flow field but the reactants are not distributed uniformly thereby degrading performance of a cell.

A porosity of the compressed graphene foam decreases slightly compared with uncompressed graphene foam, but the compressed graphene foam still has a porous structure with sufficient porosity. In addition, the reduced porosity due to compression forms smaller pores in an in-plane direction so serpentine and tortuous pathways are formed, thereby accelerating diffusion of reactants into the GDL. Moreover, the compressed graphene foam has capabilities of improved reactant transport and removing water thereby improving performance as a flow field in high current density regions. Furthermore, the compressed graphene foam is capable of functioning as a flow field without additional treatment because of having similar characteristics with a conventional flow field.

However, excessively compressing the graphene foam blocks reactant pathways so a degree of reduction in a thickness thereof is needed to be optimized to provide an appropriate trade-off between retention time of reactants and mass transport of reactant and product.

In addition, a type of the fuel cell is not specifically limited, but as an example, the fuel cell may be a polymer electrolyte membrane fuel cell (PEMFC).

Furthermore, the present invention provides a fuel cell having the component functioning as the flow field and the GDL. The configuration of the fuel cell according to the present invention remains the same as in the related art fuel cell except for the fact that this fuel cell includes a component functioning as a flow field.

As an example of the fuel cell, the present invention provides the fuel cell including: a stack laminated with multiple single cells composed by sequentially binding the CCM, configured to bind anode and cathode on each side of an electrolyte membrane containing an electrolyte, and the bipolar plate and the component functioning as the flow field and the GDL sequentially bound on each side of the CCM; an inlet line connected to the stack to supply gas to an inside of the stack; an outlet line connected to the stack to discharge gas from the stack; and a heat exchanger connecting the inlet line and the outlet line to heat-exchange inlet gas flowing through the inlet line and outlet gas flowing through the outlet line.

The flow field of the fuel cell according to the present invention is made of the graphene foam that enhances mass transport and suffers no corrosion under operating conditions of the fuel cell when compared with the conventional flow fields, thereby realizing excellent performance and durability. In particular, the compressed graphene foam has smaller in-plane pores due to compression so has more tortuous pathways for flowing reactants, thereby accelerating diffusion of reactants into the GDL. Additionally, large through-plane pores included in the graphene foam transport reactants to entire areas of a catalyst layer. Furthermore, faster flow velocity compared with the conventional MEA is derived from a decreased flow field width due to compression, thereby facilitating the dragging of water droplets generated from reaction through unused reactant flow to outside. Therefore, mass transport of reactants and products is improved, and particularly, performance of the fuel cell is improved at high current density regions.

Hereinbelow, the present invention will be described in detail with reference to specific examples. However, it should be understood that the examples of the present invention may be changed to a variety of examples and the scope and spirit of the present invention are not limited to the example described hereinbelow. In the following examples disclosed herein are merely representative for purposes of helping more comprehensive understanding of the present invention.

### PREPARATION EXAMPLE

### Manufacture of a MEA having a Component Functioning as a Flow Field and a GDL made of Graphene Foam

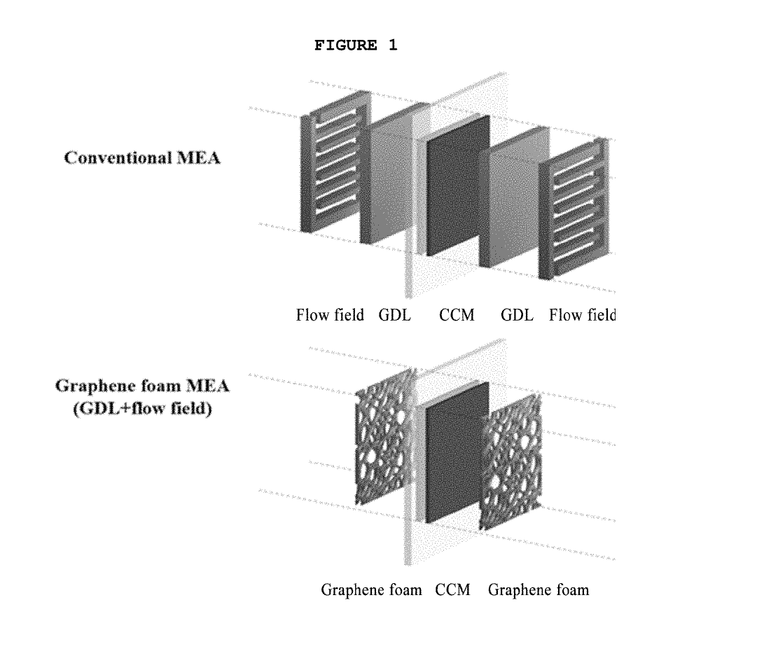

To manufacture MEA having the component functioning as the flow field and the GDL made of graphene foam shown in second one of schematic views of FIG. 1, graphene foam (Graphene Supermarket, Inc.) having average pore diameter of 580 μm and a thickness of 1 mm was disposed on a bipolar plate as a flow field and a GDL. Next, a gasket was disposed along a periphery of the graphene foam to seal gas and to easily control the thickness of the graphene foam.

The MEA was manufactured by catalyst coated membrane (CCM) method. Here, Nafion™212 was used as a polymer electrolyte membrane, the cathode and anode were formed with catalyst loading of 0.2 mg·cm⁻² on the electrolyte membrane by using catalyst ink containing 40 wt % Pt/C. The bipolar plate disposed with the graphene foam was bonded to each side of the CCM and compressive force was applied thereto to improve electrical conductivity and to accelerate diffusion of reactants thereby obtaining a MEA having the component functioning as the flow field and the GDL made of graphene foam.

The reduced thickness of the graphene foam due to compression forms smaller pores in the in-plane direction thereby accelerating diffusion of reactants. In addition, faster flow velocity compared with the conventional flow field is derived from the decreased flow field, thereby facilitating the easy dragging of water droplets formed on the graphene foam to the outside.

However, excessively thin graphene foam blocks reactant pathways so a degree of reduction in a thickness of the graphene foam is needed to be optimized to provide an appropriate trade-off between accelerating diffusion of reactants and mass transport of reactant and product.

Therefore, four different graphene foams having thickness of 100 μm, 150 μm, 200 μm, and 250 μm, respectively were manufactured and tested (hereinbelow 100 μm-GF MEA, 150 μm-GF MEA, 200 μm-GF MEA, and 250 μm-GF MEA).

### Comparative Example 1

### Manufacture of a Conventional MEA having a GDL and a Serpentine Flow Field

To manufacture a conventional MEA shown in first one of schematic views of FIG. 1, a MEA was manufactured in a same manner with preparation example except forming a GDL (Sigracet 35BC) on each side of the CCM and engraving a serpentine flow field on a bipolar plate.

### Comparative Example 2

### Manufacture of a Conventional MEA without a Flow Field of a Bipolar Plate

To confirm a GDL in the conventional MEA functions as a flow field, a conventional MEA without a flow field of a bipolar plate was manufactured.

That is, the MEA was manufactured in a same manner with comparative example 1 except the flow field of the bipolar plate was removed.

### Experimental Example

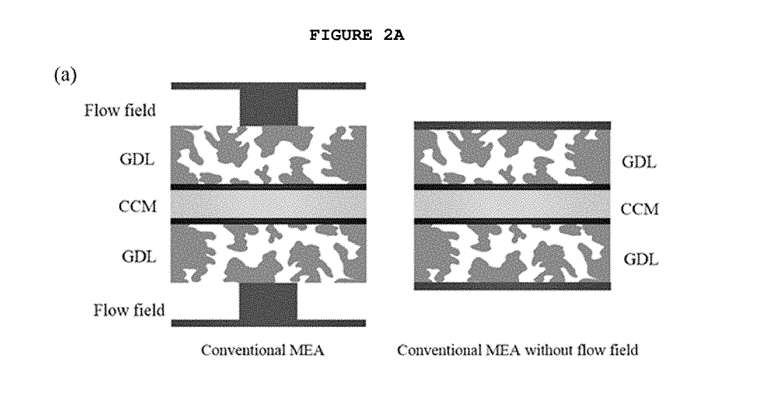

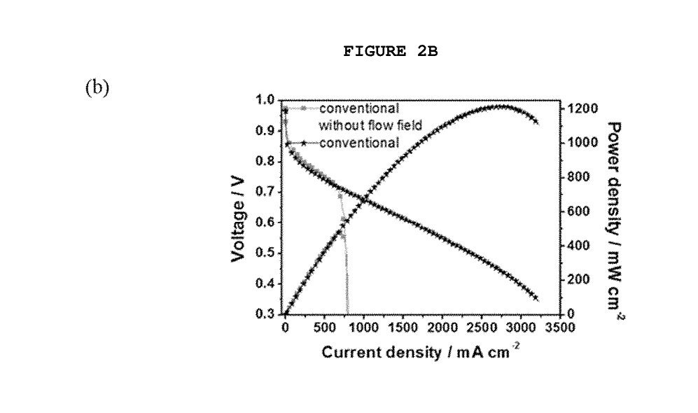

FIG. 2A shows schematic views of the conventional MEA and the conventional MEA without the flow field, and FIG. 2B shows polarization curves of the conventional MEA and the conventional MEA without the flow field, wherein the MEAs were conducted a polarization test at 70° C. H²/air, fully humidified at atmospheric pressure

Referring to FIG. 2B, current density of the conventional MEA without the flow field dropped below 0.7 A·cm⁻² unlike current density of the conventional MEA having the flow field due to insufficient supply of reactants.

That is, the GDL is made of carbon paper obtained by compressing carbon nanofiber and has through-plane pores but not in-plane pores. Therefore, the GDL is not capable of functioning as the flow field so is not proper to be used for a component functioning as the GDL and the flow field at the same time.

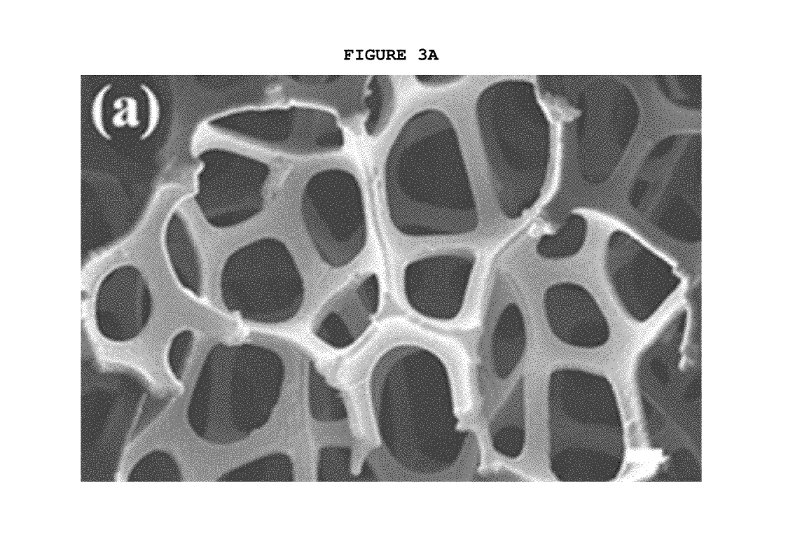

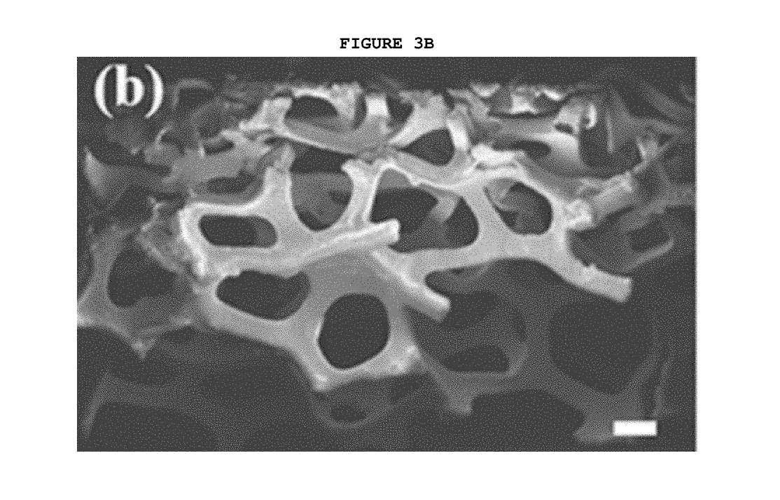

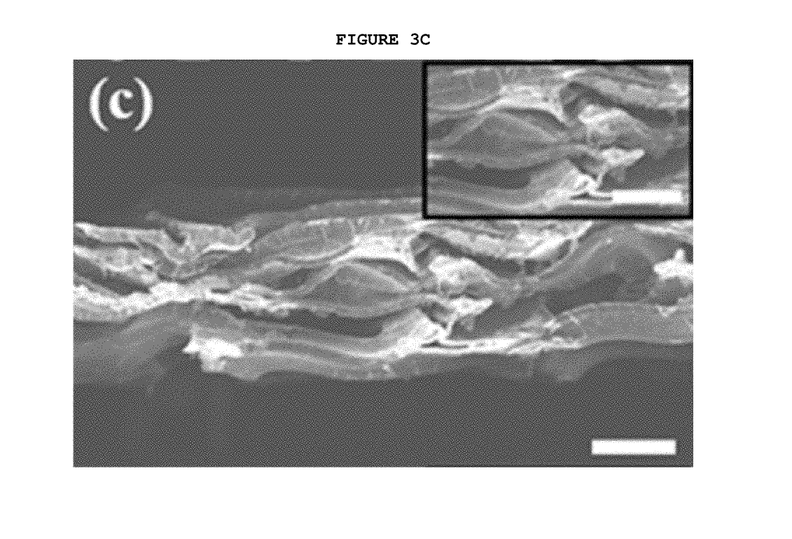

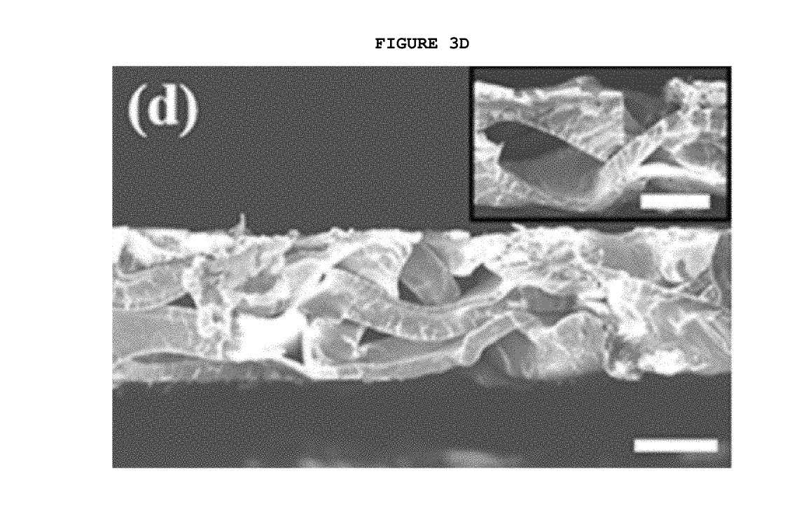

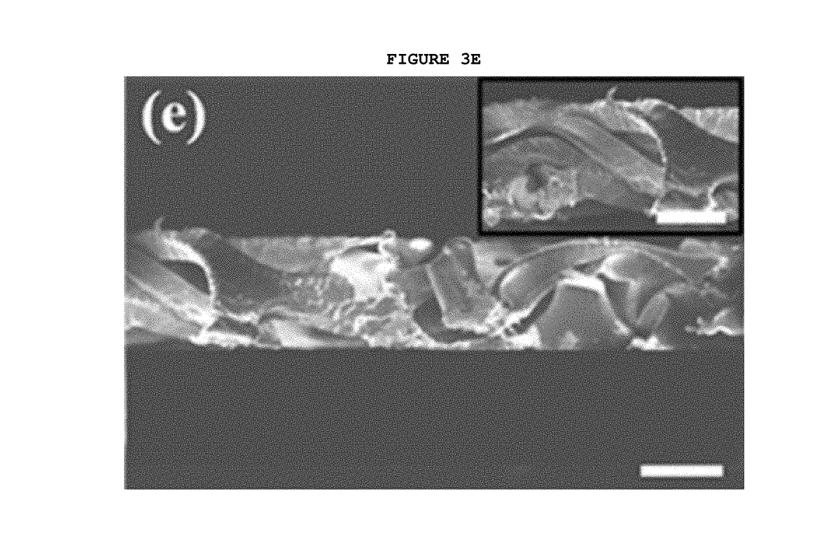

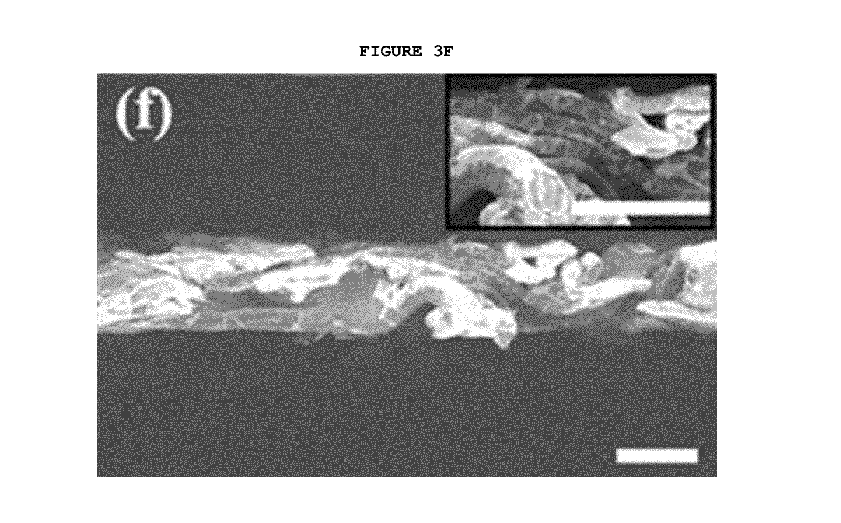

FIG. 3A is a SEM image showing a top plan view of the graphene foam before compression, FIG. 3B is a SEM image showing a cross-sectional view of the graphene foam before compression, FIG. 3C is a SEM image showing a cross-sectional view of the graphene foam after compression (thickness of 250 μm), FIG. 3D is a SEM image showing a cross-sectional view of the graphene foam after compression (thickness of 200 μm), FIG. 3E is a SEM image showing a cross-sectional view of the graphene foam after compression (thickness of 150 μm), and FIG. 3F is a SEM image showing a cross-sectional view of the graphene foam after compression (thickness of 100 μm).

After compression, all graphene foam having different thicknesses from each other showed similar plan views with FIG. 3A. The graphene foam compressed from 1 mm to 250 μm showed layer-by-layer morphology and had largest in-plane pores compared with other compressed graphene foam. FIGS. 3D and 3E show similar cross-sectional views. The graphene foam thicknesses of 150 μm and 200 μm still had in-plane pores and the graphene foam thickness of 200 μm had larger pores than the graphene foam thickness of 150 μm. Unlike other three graphene foam, in-plane pores of the graphene foam compressed from 1 mm to 100 μm were closed due to being excessively thin.

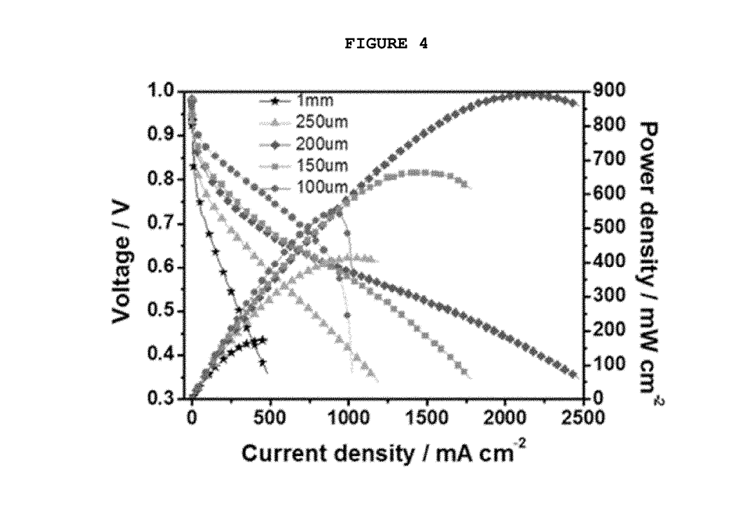

FIG. 4 shows polarization curves of the five MEAs having different thicknesses of graphene foam each other and shows performance of single cell of each MEA. Each MEA had same fuel cell components and was operated at same condition except thickness of graphene foam.

In low current density regions, when the thickness of the graphene foam was reduced, performance of single cell was improved. Activation loss was occurred in low current density regions and that is related with reaction kinetics and catalytic activity.

In general, the activation loss for each MEA having the graphene foam had to be same because the CCM and the graphene foam have similar properties. However, actual experiment results show that when the thickness of the graphene foam was reduced, the activation loss was also decreased.

The activation loss is related with exchange current density. Increased exchange current density means that the activation loss is decreased. Increasing temperature, using excellent catalysts, or increasing reactant concentration by high outlet pressure is needed to increase the exchange current density thereby decreasing the activation loss. Among those, increased reactant concentration by high outlet pressure affects the activation loss of the MEA having the graphene foam. The reason is that same CCM and fuel cell components were used and the cells were operated at same condition in experimental example. Therefore, the reduced thickness of the graphene foam increased inner pressure of the graphene foam. That is, when supplying reactants in specific flow rate, reduced volume of the graphene foam generated high pressure and decreased the activation loss. Therefore, the decreased thickness of the graphene foam decreased the activation loss at low current density regions thereby improving cell performance.

However, the five MEAs did not present same tendency at high current density regions. When compressing the graphene foam to have a thickness from 1 mm to 200 μm, cell performance was improved in entire current density regions due to increased pressure. Meanwhile, the graphene foam having a thickness less than 200 μm had reduced size of pores and deteriorated mass transport so performance thereof was deteriorated in high current density regions. In particular, current density of the 100 μm-GF MEA dropped below 1 A·cm⁻² in low current density regions despite high voltage. The results are same with the results of the conventional MEA without the flow field which means that when reducing the thickness of the graphene foam from 1 mm to 100 μm, in-plane pores are closed so reactant supply to in-plane becomes insufficient. As a result, as shown in FIG. 3D, the graphene foam having a thickness of 200 μm was optimal for best performance.

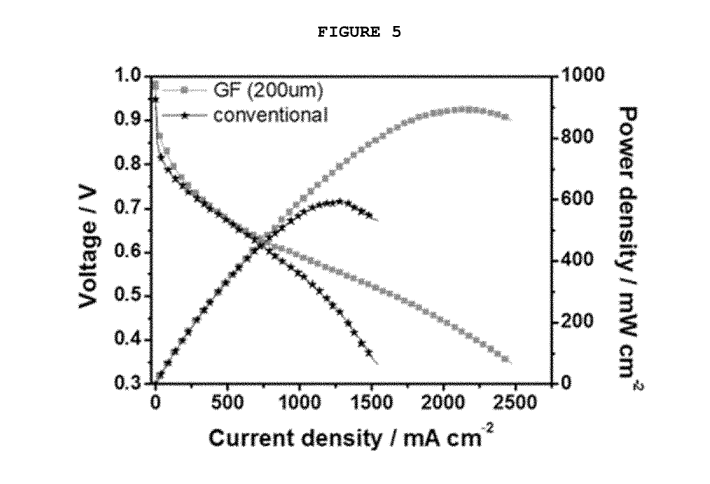

FIG. 5 and Table 1 shows caparison between the 200 μm-GF MEA and the conventional MEA. The 200 μm-GF MEA shows higher voltage than the conventional MEA in entire current density regions, in particular, voltage of the 200 μm-GF MEA was increased 56% at 0.4 V and 74% at 0.8 V compared with the conventional MEA. In low cell voltage (0.4 V), where mass transport is dominant, the 200 μm-GF MEA shows higher current density than the conventional MEA and this is because the GDL and the flow field were substituted with the graphene foam. When removing the GDL from the MEA, reactant pathways were reduced about 84% thereby reducing mass transport resistance and removing water without blocking a catalyst layer.

TABLE 1
Comparison in current densities of 200 μm-GF MEA and
conventional MEA (mA · cm⁻²)

| | 0.8 V | 0.6 V | 0.4 V |
|---|---|---|---|
| 200 μm-GF MEA | 120 (174%) | 939 (116%) | 2218 (156%) |
| Conventional MEA | 69 | 809 | 1419 |

High cell voltage (0.8 V) is related with activation polarization affected by catalyst activity and catalyst utilization. At 0.8 V, current density was 120 mA·cm², which was 74% higher than current density of the conventional MEA (69 mA·cm⁻²). That is, the 200 μm-GF MEA had reduced volume for flowing reactants, and then internal pressure was increased thereby reducing the activation loss. Such effect is similar with the effect of the outlet pressure. In other words, the 200 μm-GF MEA decreased the activation loss without outlet pressure.

In addition, increased inner pressure prevented water flooding and dragged water droplets to outside easily. Although the MEA having the graphene foam had no micro-porous layer (MPL), current density of the 200 μm-GF MEA was higher than the conventional MEA thereof at 0.6 V. While the MPL included in the conventional MEA provides large surface and excellent contact property between a carbon paper and a catalyst layer, the 200 μm-GF MEA was lack of MPL so had low electron transport and was affected in middle current density regions. However, inner pressure of the 200 μm-GF MEA was increased so the 200 μm-GF MEA shows 16% higher current density than the conventional MEA thereof at 0.6 V.

As a result, the current density of the 200 μm GF-MEA was increased by 50% and the thickness of the MEA was reduced by 85%. Therefore, volume power density can be maximized by reduced stack volume.

An oxygen gain experiment and electrochemical impedance spectroscopy (EIS) were conducted to verify an effect of the MEA having the graphene foam on the mass transport. The oxygen gain measures difference in cell voltages under oxygen-rich condition (O₂) and under oxygen-depleted condition (air). While the cell voltage under oxygen-rich condition excludes the mass transport effect, the cell voltage under air condition is affected by mass transport resistance due to decreased oxygen partial pressure and blanketing effect of nitrogen, in atmospheric condition. Therefore, the mass transport resistance can be measured by the oxygen gain. In other words, lower oxygen gain means reduced mass transport resistance thereby enhancing mass transport of reactant and product.

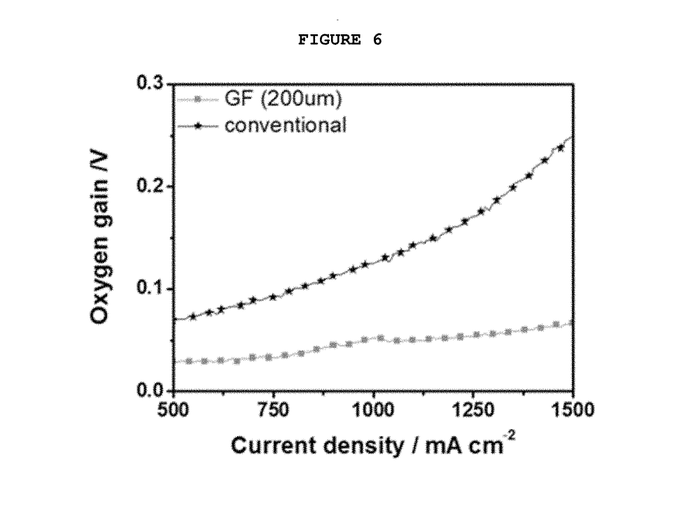

FIG. 6 shows oxygen gain graphs of the 200 μm-GF MEA and the conventional MEA. In high current density regions, oxygen gain of the 200 μm-GF MEA was much lower than the conventional MEA thereof. That is, the graphene foam substituted for the GDL and the flow field so mass transport resistance was reduced.

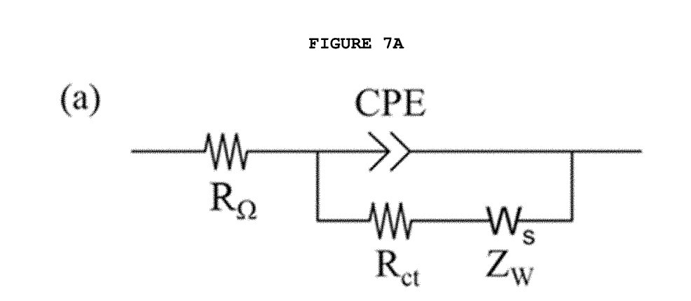

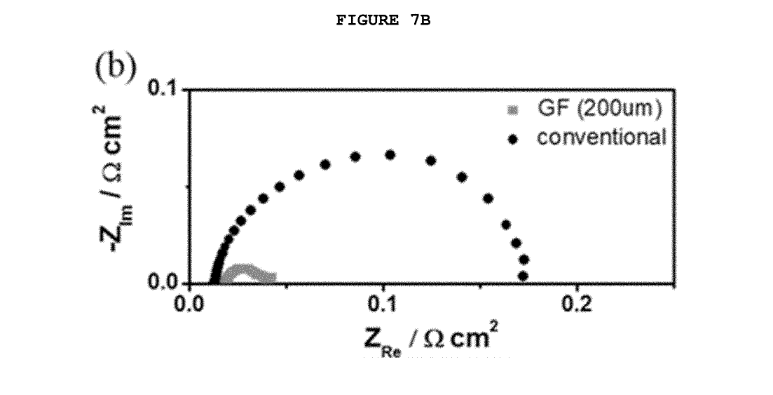

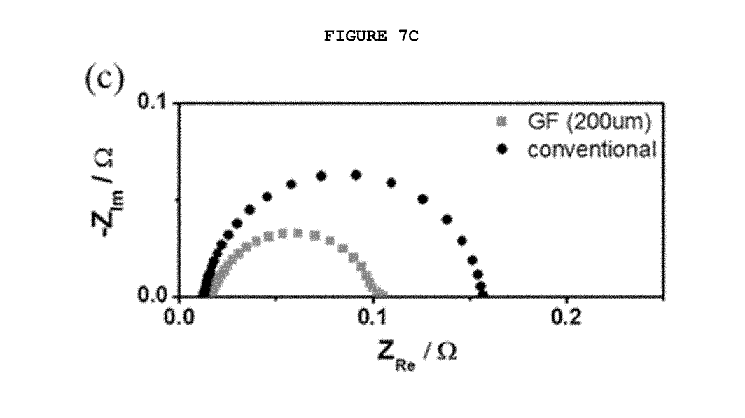

The EIS is used to measure frequency-dependent impedance of the fuel cell by applying AC potential as a perturbation signal and measuring current. The EIS has advantage of measuring independent contribution of certain component resistances such as ohmic resistance, charge transfer resistance, and mass transport resistance in total impedance. FIG. 7A shows modified Randles equivalent circuit model, purposely chosen for the present invention. FIGS. 7B and 7C are Nyquist plots showing imaginary part versus real part of impedance at each frequency. Ohmic resistance, RΩ, is the sum of ionic resistance and electronic resistance of cell components. Charge transfer resistance, R_{ct}, is related to activation loss, which is a function of catalyst surface area, catalyst concentration, and catalyst utilization. Warburg impedance, Zw, is related to mass transport resistance. In Nyquist plot, the high frequency intercept is ohmic resistance and the diameter of semicircle represents charge transfer resistance at high cell voltage (0.8 V). However, in low cell voltage (0.4 V), where mass transport polarization is dominant, a semicircle of Nyquist plot represents charge transfer resistance and mass transport resistance. That is, high-frequency semicircle means charge transfer resistance and low-frequency semicircle means mass transport resistance.

FIG. 7B shows Nyquist plots of the 200 μm-GF MEA and the conventional MEA at 0.4V. The Ohmic resistance of the 200 μm-GF MEA was higher than the conventional MEA. The reason is that electron pathway in the conventional MEA was vertical, while electron pathway in the MEA having the graphene foam was vertical and horizontal. In addition, the MEA having the graphene foam is lack of the MPL so a contact surface between the graphene foam and the catalyst layer was reduced, leading to reduced electronic conductivity and increased ohmic resistance. The 200 μm-GF MEA had higher ohmic resistance but less mass transport resistance. The result means that the MEA without the GDL using the graphene foam reduced mass transport resistance so improved mass transport thereby improving the cell performance in high current density regions.

FIG. 7C shows Nyquist plots of the 200 μm-GF MEA and the conventional MEA at 0.8V. High voltage regions (0.8 V), where activation polarization is dominant, mass transport resistance is negligible. The 200 μm-GF MEA had higher ohmic resistance but less charge transport resistance which is consistent with the result of polarization curves at low current density regions. The cell polarization curves and the EIS show that activation loss was decreased since the graphene foam was used for functioning as the GDL and the flow field. All cell components and operating conditions were same except for varying the thickness of the graphene foam such that the activation loss of the MEA having the graphene foam was affected by pressure. As shown in FIGS. 3A to 3F, compressing the graphene foam reduced the size of pores and transformed internal pore structures. Compressing the graphene foam and removing the GDL reduced volume of flowing reactants and increased internal pressure. Since the graphene foam and the catalyst layer were contacted directly, increased pressure inside of the graphene foam affected on the catalyst layer directly. The activation loss was decreased due to the pressure generated inside of the graphene foam thereby performance of the 200 μm-GF MEA in low current density regions without outlet pressure.

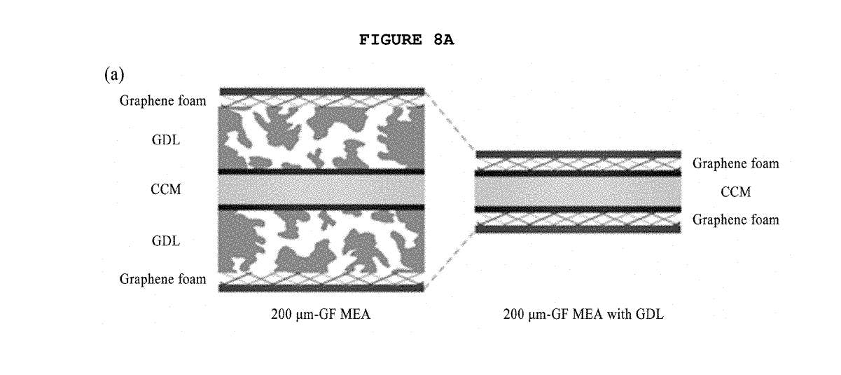

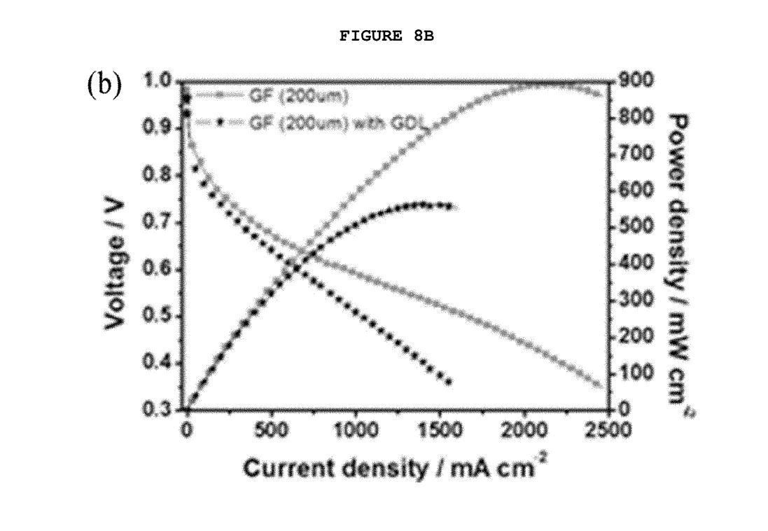

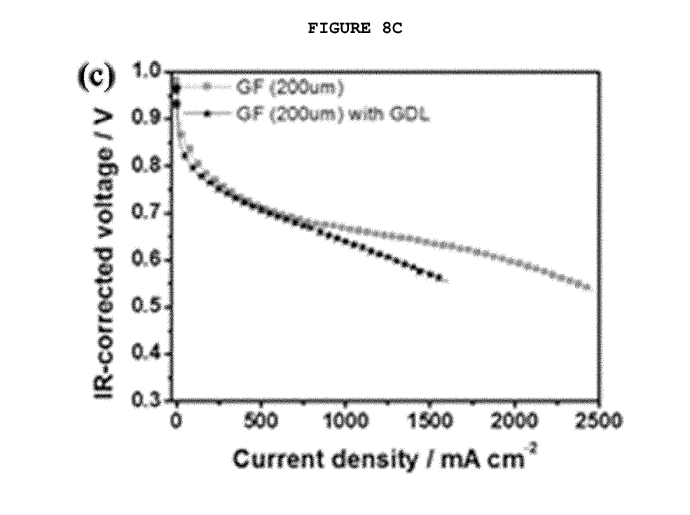

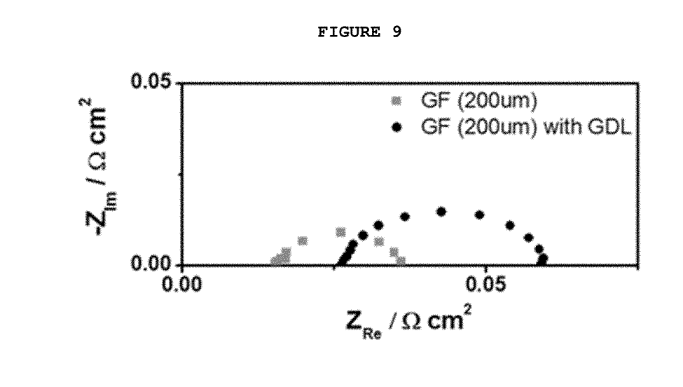

To confirm the effect of removing the GDL on cell performance, performance of the 200 μm-GF MEA and the 200 μm-GF MEA having the GDL were compared. FIG. 8A shows schematic views of the 200 μm-GF MEA and the 200 μm-GF MEA having the GDL. Except the GDL, all cell components and the thickness of the graphene foam were same. FIG. 8B shows polarization curves of the 200 μm-GF MEA and the 200 μm-GF MEA having the GDL. The 200 μm-GF MEA outperformed the 200 μm-GF MEA having the GDL in overall current density regions because the 200 μm-GF MEA had less ohmic loss than the 200 μm-GF MEA having the GDL due to elimination of the GDL. FIG. 9 shows that ohmic resistance of the 200 μm-GF MEA (0.0152Ω) was much lower than ohmic resistance of the 200 μm-GF MEA having the GDL (0.026Ω). The ohmic loss of the 200 μm-GF MEA was decreased by 42% compared with the 200 μm-GF MEA having the GDL whereby cell performance was improved.

In addition, to confirm the effect of removing the GDL on activation loss and mass transport loss, IR-corrected cell voltage removing ohmic effect about cell performance was measured.

FIG. 8C shows IR-corrected cell voltage curves of the 200 μm-GF MEA and the 200 μm-GF MEA having the GDL. By removing ohmic loss, cell voltages of the 200 μm-GF MEA and the 200 μm-GF MEA having the GDL were same in middle current density regions. In case of the 200 μm-GF MEA, internal pressure of the graphene foam was increased and affected on cell voltage. Meanwhile, the 200 μm-GF MEA having the GDL had much lower internal pressure compared with the 200 μm-GF MEA since having a thickness of 450 μm (graphene foam: 200 μm and GDL: 250 μm). Therefore, the 200 μm-GF MEA having the GDL needed larger volume for flowing reactants so was not affected by internal pressure. In high cell voltage, current density of the 200 μm-GF MEA was much higher due to increased internal pressure, and also in low cell voltage, compared with the 200 μm-GF MEA having the GDL. The internal pressure, increased by reducing the volume for flowing reactants due to lack of the GDL, enabled easy dragging of generated water. Therefore, the 200 μm-GF MEA enabled increasing internal pressure of the graphene foam and increasing activation and mass transport over potential, thereby improving cell performance in entire current density regions.

1. A component functioning as a flow field and a gas diffusion layer (GDL) of a fuel cell, the component comprising graphene foam.

2. The component of claim 1, wherein the component is a sheet or a film made of graphene foam.

3. The component of claim 1, wherein the graphene foam is compressed graphene foam.

4. The component of claim 1, wherein the fuel cell is polymer electrolyte membrane fuel cell (PEMFC).

5. The component of claim 4, wherein the component is interposed between a catalyst coated membrane (CCM) and a bipolar plate when manufacturing the fuel cell.

6. A fuel cell comprising the component functioning as the flow field and the GDL of claim 1.

7. The fuel cell of claim 6, including:
a stack laminated with multiple single cells composed by sequentially binding the CCM, configured to bind an anode and a cathode on each side of an electrolyte membrane containing an electrolyte, and the bipolar plate and the component functioning as the flow field and the GDL sequentially bound on each side of the CCM;
an inlet line connected to the stack to supply gas to an inside of the stack;
an outlet line connected to the stack to discharge gas from the stack; and
a heat exchanger connecting the inlet line and the outlet line to heat-exchange inlet gas flowing through the inlet line and outlet gas flowing through the outlet line.
